(19) United States
(12) Patent Application Publication
(10) Pub. No.: US 2008/0059413 A1
(43) Pub. Date: Mar. 6, 2008

(54) Apparatus and method for an extended semantic layer with multiple combined semantic domains specifying data model objects

(75) Inventors: Luke William Evans, Vancouver (CA); Richard David Webster, Richmond (CA); Richard Bruce Cameron, Vancouver (CA)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/515,404

(22) Filed: Aug. 31, 2006

(51) Int. Cl. G06F 17/30

(52) U.S. Cl. 707/2

(57) ABSTRACT

A computer readable storage medium includes executable instructions to define a first semantic domain and specify a second semantic domain. The first semantic domain and second semantic domain are combined to establish a third semantic domain. At least one base dimension is identified as a data model object for the third semantic domain. At least one base measure is formed as a data model object for the third semantic domain.

### CROSS REFERENCE TO RELATED APPLICATIONS

This application shares a common specification with the commonly owned and concurrently filed patent application entitled, “Apparatus and Method for an Extended Semantic Layer Specifying Data Model Objects with Calculated Values”, Ser. No. ______, filed Aug. 31, 2006. This application is also related to the commonly owned and concurrently filed patent application entitled, “Apparatus and Method for Processing Queries Against Combinations of Data Sources”, Ser. No. ______, filed Aug. 31, 2006.

### BRIEF DESCRIPTION OF THE INVENTION

This invention relates generally to semantic layers used to interface with data sources. More particularly, the invention relates to the abstraction of a group of semantic domains that represent enriched abstractions of relational, OLAP, other data sources and combinations thereof, along with data model objects within these semantic domains.

### BACKGROUND OF THE INVENTION

Business Intelligence generally refers to software tools used to improve business enterprise decision-making. These tools are commonly applied to financial, human resource, marketing, sales, customer, and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases, On Line Analytic Processing (OLAP) systems, or other data sources used to collect, store, and manage raw data.

In many organizations data is stored in multiple formats that are not readily compatible, such as relational and OLAP data sources. Additionally, in many organizations it is desirable to insulate a user from the complexities of the underlying data source. Therefore, it is advantageous to be able to work with data using a semantic layer that provides terms and abstracted logic associated with the underlying data.

Semantic layers for relational databases are known in the art. It would be advantageous to enhance the architecture of known semantic layers to support abstractions of custom calculated dimensions and measures and to support the concept of hierarchies for dimensions. Likewise, it would be advantageous to define relational, OLAP, and other data sources as semantic domains containing data model objects. This would allow multiple relational, OLAP, and other data sources or combinations thereof to be combined in a unified semantic domain.

### SUMMARY OF THE INVENTION

The invention includes a computer readable storage medium with executable instructions to define a first semantic domain and specify a second semantic domain. The first semantic domain and second semantic domain are combined to establish a third semantic domain. At least one base dimension is identified as a data model object for the third semantic domain. At least one base measure is formed as a data model object for the third semantic domain.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates an architecture related to the structure of semantic domains in accordance with an embodiment of the invention.

FIG. 3 illustrates a workflow for defining a semantic domain that describes a relational data source in accordance with an embodiment of the invention.

FIG. 4 illustrates a workflow for defining a semantic domain that describes an OLAP data source in accordance with an embodiment of the invention.

FIG. 5 illustrates a workflow for defining a semantic domain that combines two semantic domains in accordance with an embodiment of the invention.

FIG. 6 illustrates a workflow for defining a calculated data model object in accordance with an embodiment of the invention.

FIG. 7 illustrates a workflow for defining a semantic domain that describes other data sources, such as pre-existing semantic layers, a range of data file formats, or other data source types in accordance with an embodiment of the invention

Like reference numerals refer to corresponding parts throughout the several views of the drawings.

### DETAILED DESCRIPTION OF THE INVENTION

The following terminology is used while disclosing embodiments of the invention:

Semantic Domain is the term for a level of abstraction based on a relational, OLAP, or other data source. The abstraction may be based upon a combination of existing semantic domains. The semantic domain includes data model objects that describe the underlying data source and define dimensions, attributes and measures that can be applied to the underlying data source. The semantic domain may include data foundation metadata that describes a connection to, structure for, and aspects of the underlying data source. The term Combined Semantic Domain in particular is used to describe a semantic domain that describes the combination of two or more existing semantic domains where the combined existing semantic domains include semantic domains that describe a relational data source, OLAP data source, other data source, or another combined semantic domain.

Data Model Object is the term for an object defined within a semantic domain that represents, defines, and provides metadata for a dimension, attribute or measure in an underlying data source. Data model objects can contain calculations from, based on or designed to be applied to an underlying data source. Types of data model objects include base dimensions, base attributes, base measures, calculated dimensions, calculated attributes, and calculated measures.

Base Dimension is a type of data model object that represents a side of a multidimensional cube, a category, a column, or a set of data items within a data source. Each dimension represents a different category, such as region, time, or product type. Base dimension definitions support the specification of hierarchies. Members of a base dimension may be defined through a filter or transform.

Base Measure is a type of data model object that describes an aggregation of underlying data values based on governing dimensions. In the case of an OLAP data source, the measure may be defined directly in the source data. In the case of a relational data source, a column (or query expression), aggregation type, and governing dimensions are defined for the base measure. Types of aggregations include sum, count, maximum, minimum, average, first child, last child, and the like.

A Base Attribute is a type of data model object that is associated with a dimension and for each member for the dimension there is an attribute value. For example, a customer dimension might have base attribute values for age, gender, and phone.

A Calculated Attribute is a type of data model object that is associated with a dimension and for each member of the dimension there is a calculated attribute value.

Calculated Dimension is a type of data model object where a dimension object contains members that are produced by a calculation. Members are determined dynamically based on the transformation of the underlying data or explicitly specified and bound to calculations. Member levels and hierarchies may be calculated as an aspect of a calculated dimension.

Calculated Measure is a type of data model object that is not bound directly to the underlying database. Instead, the object has a value expression that is evaluated to produce the value for the measure. These expressions may reference values of other measures (base measures or calculated ones) and may reference base and calculated dimensions for constraints and contexts. Calculated measures refer to values or ranges of values of a current measure or any other measures across subsets of the dimension space. Calculated measures can be used to calculate lead/lag ranges, and the like.

Base Dimension Member is the term used to describe a distinct value within a base dimension, where the distinct value has a unique ID, display name, or attributes.

Hierarchy is the term used to describe the specified arrangement of base dimension members within a base dimension. A base dimension contains one or more hierarchies. Members are associated with a level within the base dimension. Members can be arranged as children of other members and form tree structures. Levels generally (but not necessarily) correspond to different depths within a hierarchy. A typical example is a geography hierarchy where levels include, country, state, city, store and the like. A hierarchy is used to interpret the calculation of measures, dimensions, and queries.

Data foundation is the term used to describe metadata that describes how to access a data source. A data foundation may include metadata specifying the data structure and aspects of the data in the underlying data source, including the relationships between the data items.

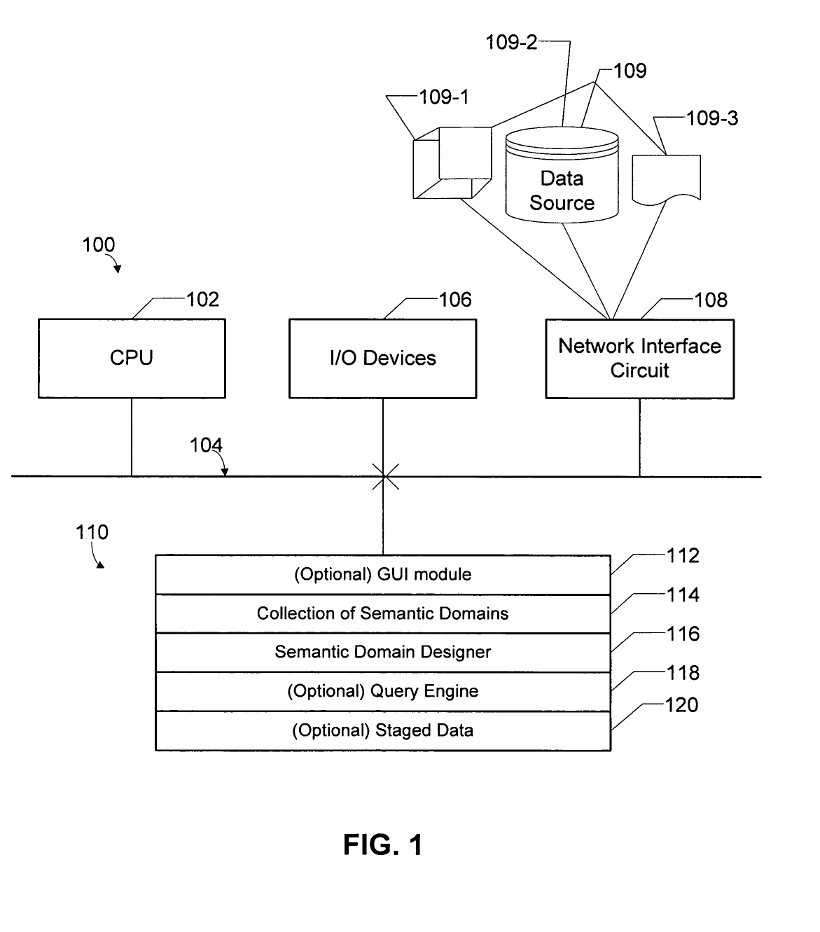

FIG. 1 illustrates a computer 100 configured in accordance with an embodiment of the invention. The computer 100 includes standard components, including a central processing unit 102, a bus 104, input/output devices 106, and an optional network interface circuit 108. The input/output devices 106 may include devices such as a keyboard, mouse, a display, such as a monitor and the like.

The optional network interface circuit 108 facilitates communications with networked computers (not shown) and data sources 109. Data sources include OLAP databases 109-1, relational databases 109-2, data files 109-3, other database types, warehouses, and the like. The computer 100 also includes a memory 110. The memory 110 includes executable instructions to implement operations of the invention.

In the example of FIG. 1, the memory 110 includes an optional GUI module 112 to provide capability to facilitate the creation, modification and querying of semantic domains and collections of semantic domains. The memory 110 also stores a collection of one or more semantic domains 114. A semantic domain designer 116 facilitates the design of semantic domains. The semantic domain designer 116 may be configured to design data model objects associated with semantic domains stored in memory 110. Optionally, a query engine 118 facilitates running queries based on a semantic domain. Optionally, staged data 120 is stored in memory 110 to support the activities of the query engine 118 and/or semantic domain designer 116.

For the purposes of illustration, the components are shown on a single computer. Modules may be located on different computers. It is the functions of the modules that are significant, not where they are performed or the specific manner in which they are performed.

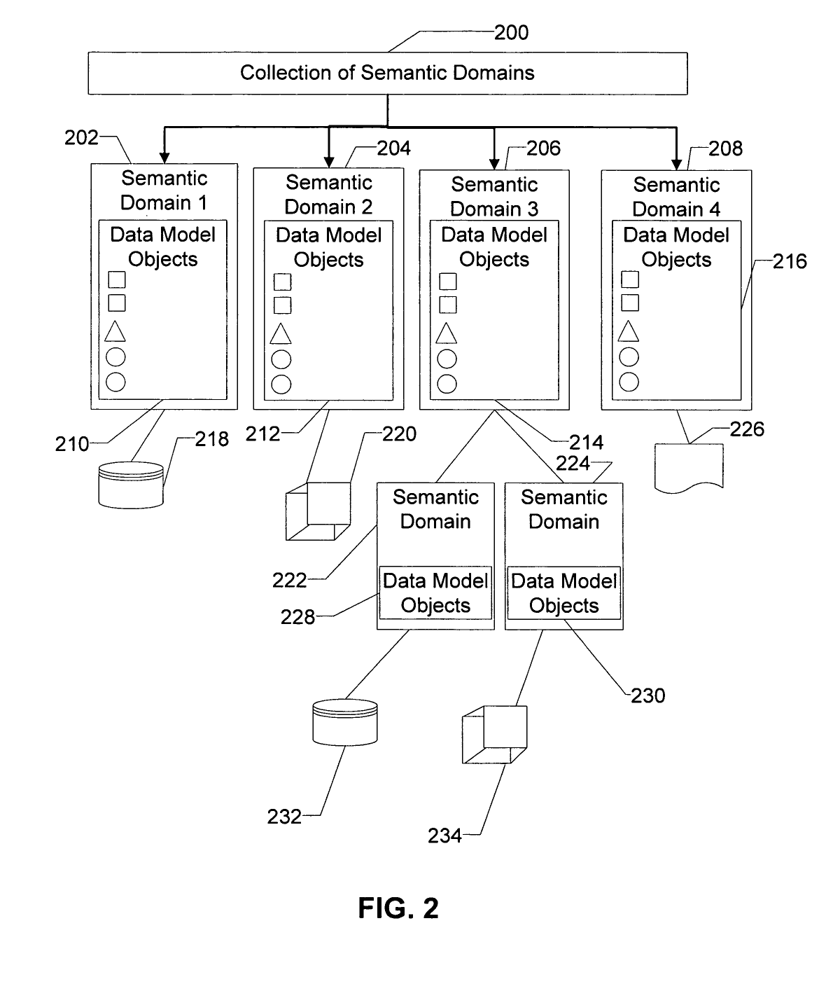

FIG. 2 illustrates an architecture related to the structure of semantic domains in an embodiment of the invention. A collection of semantic domains 200 contains multiple semantic domains: Semantic Domain 1 202, Semantic Domain 2 204, Semantic Domain 3 206, and Semantic Domain 4 208. The collection of semantic domains can contain any number of semantic domains or can exist as an empty collection. The semantic domains describe underlying data sources 218, 220, 226, 232, and 234, where the underlying data sources include relational data sources 218, OLAP data sources 220, other data sources 226 and existing semantic domain definitions 222, 224 that provide definitions to describe data sources 232 and 234. In the case of underlying data sources 232 and 234, these data sources have defined semantic domains 222 and 224, respectively, which describe the underlying data and are used to facilitate creating a combined Semantic Domain 3206. Semantic Domain 3 206 describes both of the underlying data sources and establishes the logic for data model objects used against the combined data source logic.

Each of the semantic domains 202, 204, 206, 208, 222, and 224 contains groups of defined data model objects 210, 212, 214, 216, 228, 230 and data foundation metadata. These groups of data model objects can contain any number of data model objects or can exist as an empty collection. For example, the types of data model objects contained in the data model object groups include objects representing base dimensions, base attributes, base measures, calculated dimensions, calculated attributes, and calculated measures. The base dimensions and measures describe aspects of the underlying data sources 218, 220, 226, 232, and 234.

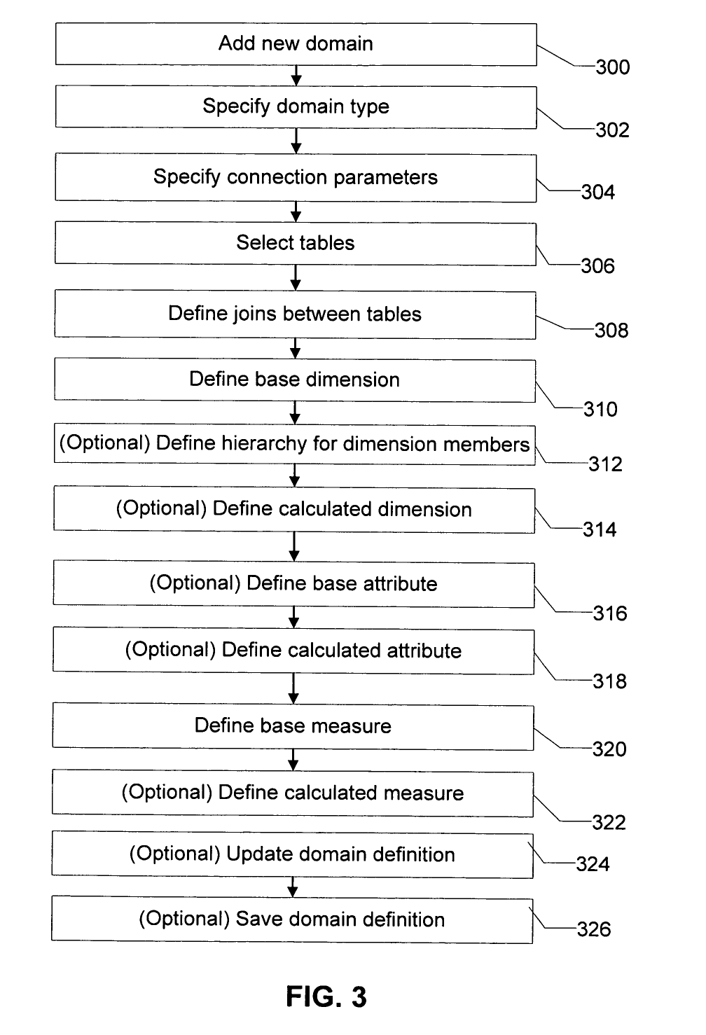

FIG. 3 illustrates a workflow associated with an embodiment of the invention for defining a semantic domain that represents an underlying relational data source. Operations associated with this workflow may be performed by Semantic Domain Designer 116 either independently or in conjunction with an optional GUI module 112. Add a new domain 300 creates a new empty domain and typically includes instructions for specifying a name for the new semantic domain. Specify domain type 302 enables the user to define the type of semantic domain where options may reference specific database product types or general data source types. Examples of specifying domain types include relational (Oracle), relational (ODBC), OLAP (Oracle), OLAP (ODBO), Combined and the like. In the case of a semantic domain based on a relational data source, the user specifies a domain of one of the types associated with a relational type. Specify connection parameters 304 collects information needed to connect to the underlying data source such as server, port, database, schema, user, password and the like. Select tables 306 collects information regarding the database tables on which the relational semantic domain is based. Define joins between tables 308 enables the user to define joins and join directions between tables in the relational data foundation to construct relationships between data model objects.

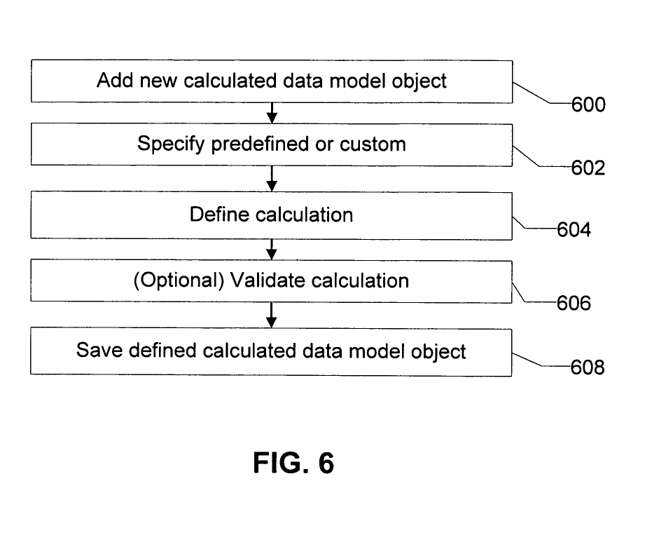

Define base dimension 310 specifies one or more base dimensions for the semantic domain. Optionally, a hierarchy can be applied to the dimension members 312 such that a hierarchical structure for the dimension members is applied when members are interpreted by calculations and queries. Optionally, one or more calculated dimension can be defined 314, where the definition of the calculated dimension includes using an expression language to define the dimension either distinctly from other dimensions or measures, or in reference to existing dimensions and measures. The definition of a calculated dimension can include a calculated hierarchy for dimension members or reference an existing hierarchy for the dimension members. FIG. 6 illustrates a workflow for defining a calculated data model object.

Optionally define base attribute 316 specifies one or more relationships between a base or calculated dimension member defined for the semantic domain and an attribute associated with the dimension member.

Optionally define calculated attribute 318 specifies one or more calculated relationships between a base or calculated dimension member defined for the semantic domain and an attribute associated with the dimension member, where the calculation can either determine the logic of the relationship or transform aspects of the attribute value.

Define base measure 320 specifies one or more measures based on the underlying data source. In a typical embodiment, defining a base measure includes selecting a column from a fact table or constructing a query expression based on a data source, specifying an aggregation type, specifying one or more governing dimension, or optionally customizing the aggregation type for specific governing dimensions. Aggregation types include sum, count, maximum, minimum, average, first child, last child, none and the like. Customizing the aggregation type by dimension is used in a number of standard measures, such as an inventory measure where the product related dimensions are aggregated by sum, but the time related dimensions are aggregated by ‘last child’.

Optionally, calculated measures are defined 322. A workflow for defining calculated measures and dimensions is illustrated in FIG. 6. The semantic domain definition can be updated 324 using the semantic domain designer 116, optionally in conjunction with GUI module 112. Updating includes modifying aspects of the data foundation definition and modifying, adding, or deleting data model objects. Optionally, the semantic domain definition is saved 326 to a collection of semantic domains 114 where it is available as a definition for the query engine 118.

In a typical embodiment, the workflow to define base and calculated dimensions and measures for a semantic domain does not require that the data model objects be defined in any order unless the data model object itself has a logical dependency on another data model object. Additionally, definitions related to the data foundation, such as specifying connection attributes and schema structure (tables and joins in the relational case) can be updated or redefined later during the workflow.

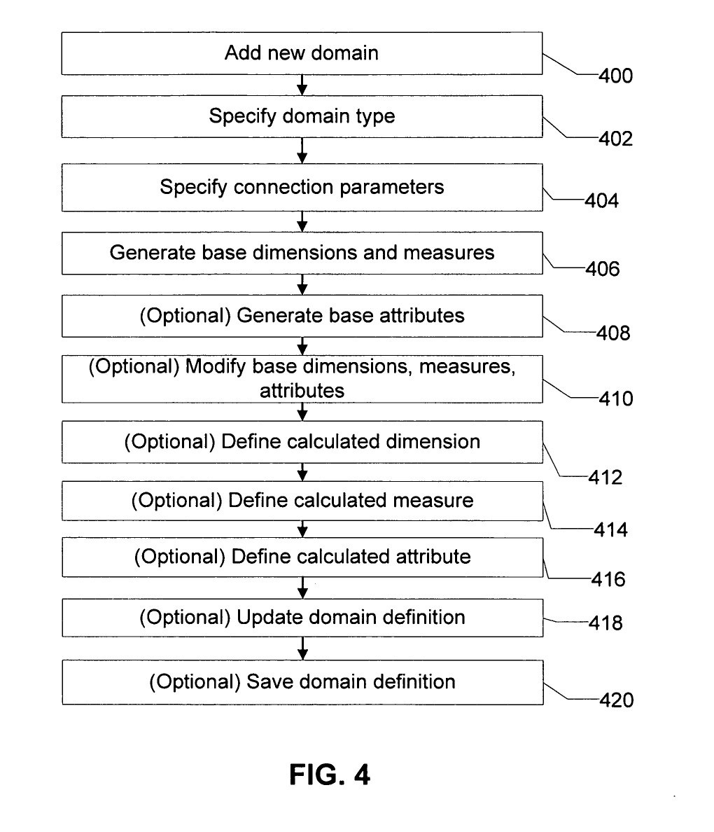

FIG. 4 illustrates a workflow associated with defining a semantic domain that represents an underlying OLAP data source in an embodiment of the invention. Operations associated with this workflow may be performed by Semantic Domain Designer 116 either independently or in conjunction with an optional GUI module 112. Add a new domain 400 creates a new empty domain and typically includes instructions for specify a name for the new semantic domain. Specify domain type 402 enables the user to define the type of semantic domain, where options may reference specific database product types or general data source types. In the case of a semantic domain based on an OLAP data source, the user specifies a domain of one of the types associated with an OLAP type. Specify connection parameters 404 collects information needed to connect to the underlying data source, such as server, port, database, schema, user, password and the like.

Based on the metadata contained in the specified OLAP data source, base dimensions and measures are automatically generated 406. Optionally, based on the metadata contained in the specified OLAP data source, base attribute relationships for dimension members are automatically generated 406. In one embodiment of the invention, a dimension, a measure and an attribute are respectively generated in the semantic domain for each dimension, measure and attribute in the underlying data source. The underlying data source may contain zero or more dimensions, measures, and attributes. Optionally, the user may change the selection of base dimensions, attributes and measures 410 defined within the semantic domain. Optionally, the user may also define a calculated dimension 412, calculated measure 414, or calculated attribute 416 within the semantic domain. FIG. 6 illustrates a workflow for defining a calculated data model object. The semantic domain definition can be updated 418 using the semantic domain designer 116, optionally in conjunction with GUI module 112. Optionally, the semantic domain definition is saved 420 to a collection of semantic domains 114 where it is available as a definition for the query engine 118.

In a typical embodiment, the workflow to define data model objects does not require that the data model objects be defined in any order unless the data model object itself has a logical dependency on another data model object.

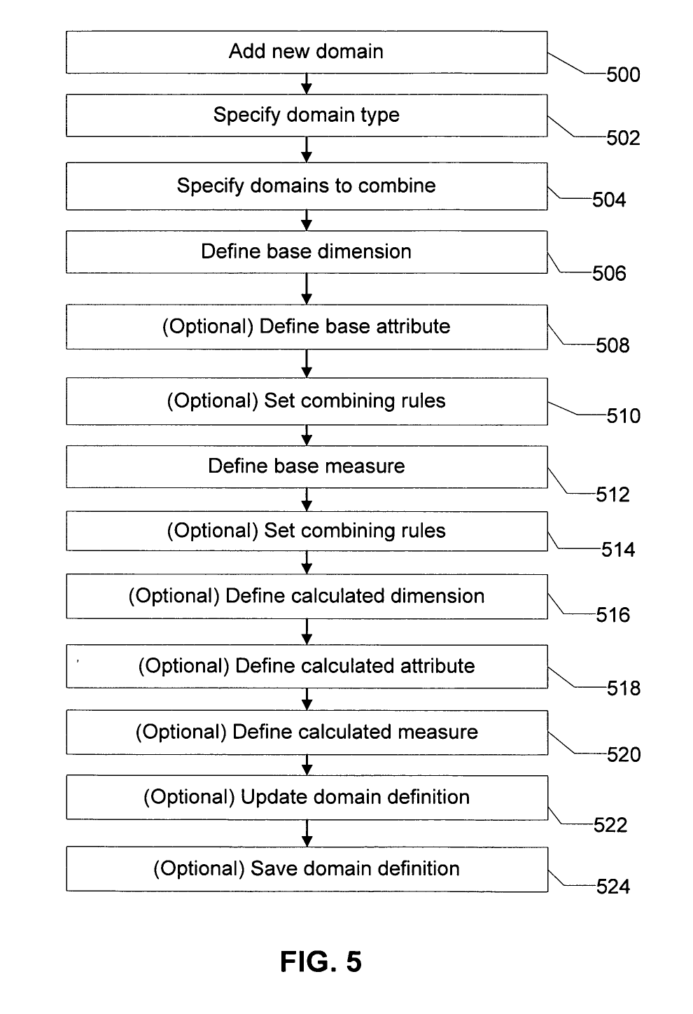

FIG. 5 illustrates a workflow associated with an embodiment of the invention that defines a semantic domain that represents a combination of two or more underlying semantic domains. Operations associated with this workflow may be performed by Semantic Domain Designer 116 either independently or in conjunction with an optional GUI module 112. Add a new domain 500 creates a new empty domain and typically includes instructions for specify a name for the new semantic domain. Specify domain type 502 enables the user to define the type of semantic domain where options may reference specific database product types or general data source types. In the case of a combined semantic domain, the user specifies the domain type as combined. Specify domains to combine 504 defines the semantic domains to be combined. Any previously defined semantic domain, including combined semantic domains, may be specified as a domain in a combined semantic domain.

When data model objects in a first underlying semantic domain are evaluated within a second combined semantic domain, regardless of whether the data model object was considered a base or calculated data model object in the first underlying semantic domain, it is evaluated as a base dimension, attribute, or measure in the second combined semantic domain. Define base dimension 506 enables the specification of one or more dimensions from the underlying semantic domains to define dimensions within the new semantic domain. The base dimensions can refer to only one of the underlying semantic domains or can be used to refer to one or more of the dimensions in one or more of the underlying semantic domains. Optionally, define base attribute 508 specifies one or more relationships between a dimension member defined for the semantic domain and an attribute associated with the dimension member.

Optionally, in the case where dimensions combine existing dimensions in the underlying semantic domains, combining rules are specified 510 to provide instructions for the logic that is used when combining the dimensions. Dimension combining rules may indicate that the dimension members are based solely on the members from one of the component domains, which may be desired if the members in one dimension are a superset of the members from another dimension or if each of the dimensions has the same members. Other combining rules for dimensions involve integrating the members from the component dimensions into a single dimension. The individual member hierarchies can be concatenated at a level or the member hierarchies can be merged. Additional rules may be specified to control how conflicting member information should be resolved. Custom rules can also be specified to control the combination of dimensions. Dimension combining rules can be based on attributes and attribute values associated with dimension members.

Similarly, defining a base measure specifies one or more measures from the underlying semantic domains to define measures 512 within the new semantic domain. The measures can refer to only one of the underlying semantic domains or can refer to two or more of the underlying semantic domains.

Optionally, in the case where measures combine existing measures in the underlying semantic domains, combining rules are specified 514 to provide instructions for the logic that is used when combining the measures. Measure combining rules control how a value for the combined measures is derived from the values of the component measures. Typically, if a value only exists for one of the component measures for a given evaluation context, then the combined measure will use that value. If values exist for more than one of the component measures, then the combining rules indicate that the value from one of the component measures is preferred or that the values should be combined in a specific way, including using an aggregation function or the like. Custom rules can also be specified to control the combination of measures.

Optionally, calculated dimensions 516, calculated attributes 518 and calculated measures 520 are defined for the new combined semantic domain. The semantic domain definition can be updated 522 using the semantic domain designer 116, optionally in conjunction with GUI module 112. In a typical embodiment, the workflow to define data model objects does not require that the data model objects be defined in any order unless the data model object itself has a logical dependency on another data model object. Optionally, the combined semantic domain definition is saved 524 to a collection of semantic domains 114, where it is available as a definition for the query engine 118.

In one embodiment, a combined semantic domain contains two or more semantic domains where one or more of the semantic domains represent a combined semantic domain. Recursively, in turn one or more of the semantic domains contained at each level can represent a combined semantic domain. In this way, even if only two semantic domains are explicitly combined any number of data sources can be implicitly combined. Rule complexity is enhanced by leveraging the different levels at which semantic domains are combined.

FIG. 6 illustrates a workflow associated with on embodiment of the invention for creating a calculated data model object. A new calculated data model object is added 600 to a semantic domain. Adding creates a new empty calculated data model object and typically includes instructions for specifying a name for the new data model object. The data model object can be specified as a dimension, attribute, or measure object. Specify predefined or custom 602 selects whether to base the calculation data model object on existing defined logic or fully custom logic using an expression language. The calculation is defined 604 using either guidance through pre-existing calculation logic or through a definition in an expression language. Optionally, the calculation is validated 606 to confirm that the logic within the calculation data model object corresponds with the dimensions, attributes and measures defined for the underlying data source and to validate the specific logic within the calculation expression itself. The defined calculated data model object is saved 608, depending on its definition either as a dimension or measure associated with a semantic domain.

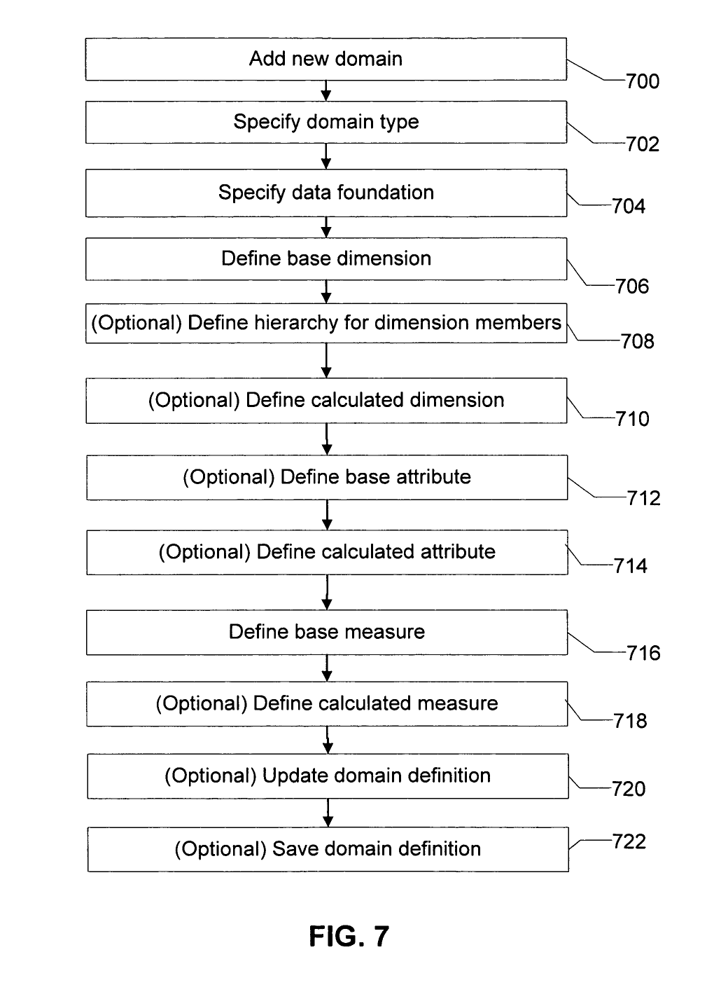

FIG. 7 illustrates a workflow associated with an embodiment of the invention for defining a semantic domain that is based on a data source other than a relational data source, an OLAP data source, or an underlying data source that already exists. Operations associated with this workflow may be performed by Semantic Domain Designer 116 either independently or in conjunction with an optional GUI module 112. Add a new domain 700 creates a new empty domain and typically includes instructions to specify a name for the new semantic domain. Specify domain type 702 defines the type of semantic domain where options may reference specific database or file types or general data source types. Examples of specifying domain type include XML file, Microsoft Excel™ XLS file, text file, semantic layer definition, CSV (Comma Separated Value) file, and the like. Specify data foundation 704 includes specifying one or more existing files, such as semantic layers, XSD files, schema files, and the like, or entering values to describe the underlying data source, such as attributes characterizing how to access the data source, the data structure, aspects of the data, relationships between data items, and the like.

Define base dimension 706 specifies one or more base dimensions for the semantic domain. Optionally, a hierarchy is applied to the dimension members 708, such that a hierarchical structure for the dimension members is applied when members are interpreted by calculations and queries. Optionally, one or more calculated dimensions are defined 710, where the definition of the calculated dimension includes using an expression language to define the dimension, either distinctly from other dimensions or measures, or in reference to existing dimensions and measures. The definition of a calculated dimension can include a calculated hierarchy for dimension members or reference an existing hierarchy for the dimension members.

Optionally, define base attribute 712 specifies the definition of one or more relationships between a base or calculated dimension member defined for the semantic domain and an attribute associated with the dimension member. Optionally, define calculated attribute 714 specifies one or more calculated relationships between a base or calculated dimension member defined for the semantic domain and an attribute associated with the dimension member, where the calculation can either determine the logic of the relationship or transform aspects of the attribute value.

Define base measure 716 specifies one or more measures based on the underlying data source. Customizing the aggregation type by dimension is used in a number of standard measures, such as an inventory measure where the product related dimensions are aggregated by sum, but the time related dimensions are aggregated by ‘last child’. Optionally, calculated measures are defined 718. Workflow details for defining calculated measures and dimensions are illustrated in FIG. 6. The semantic domain definition can be updated 720 using the semantic domain designer 116, optionally in conjunction with GUI module 112. In a typical embodiment, the workflow to define base and calculated dimensions and measures for a semantic domain does not require that the data model objects be defined in any order unless the data model object itself has a logical dependency on another data model object. Optionally, the semantic domain definition is saved 722 to a collection of semantic domains 114 where it is available as a definition for the query engine 118.

In one embodiment of the invention, the definition for a semantic domain is declarative and uses a lazy evaluation strategy, where any function only explores enough of its arguments in order to produce a result. In a functional embodiment, the semantic domain declares the data logic, evaluates a broad range of expressions (including strong typing) and maintains precision within the data definition. The semantic domain provides reusable logic (e.g., based on strong typing, lazy evaluation, and/or readily combinable functional units).

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C#, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
define a first semantic domain;
specify a second semantic domain;
combine the first semantic domain and second semantic domain to establish a third semantic domain;
identify at least one base dimension as a data model object for the third semantic domain; and
form at least one base measure as a data model object for the third semantic domain.

2. The computer readable storage medium of claim 1, wherein the first semantic domain describes one view of a first data source and the second semantic domain describes a second different view of the first data source.

3. The computer readable storage medium of claim 1, wherein the first semantic domain describes a first view of a first data source and the second semantic domain describes a second view of a second data source.

4. The computer readable storage medium of claim 1, wherein at least one of the first semantic domain and second semantic domain defines more than one data source.

5. The computer readable storage medium of claim 1 further comprising executable instructions to display a graphical user interface to facilitate the definition of semantic domains and combinations of semantic domains.

6. The computer readable storage medium of claim 1 further comprising executable instructions to define a base dimension that includes values from at least one of the first semantic domain and the second semantic domain.

7. The computer readable storage medium of claim 1 further comprising executable instructions to define a base measure based on at least one of the first semantic domain and the second semantic domain.

8. The computer readable storage medium of claim 1 further comprising executable instructions to define a calculated dimension that includes values from at least one of the first semantic domain and the second semantic domain.

9. The computer readable storage medium of claim 1 further comprising executable instructions to define a calculated measure based on at least one of the first semantic domain and the second semantic domain.

10. The computer readable storage medium of claim 1 further comprising executable instructions to define a hierarchical dimension that includes values from at least one of the first semantic domain and the second semantic domain.

11. The computer readable storage medium of claim 3 wherein the first semantic domain and the second semantic domain are based upon at least one of: a relational database, an OLAP database, an unstructured file, a structured file, and a previously defined semantic domain that describes two or more other underlying data sources.

12. The computer readable storage medium of claim 1 further comprising executable instructions to:
establish at least one base dimension as a data model object for the first semantic domain;
specify at least one base measure as a data model object for the first semantic domain; and
compute at least one of a calculated measure or a calculated dimension as a data model object for the first semantic domain.

13. The computer readable storage medium of claim 12 further comprising executable instructions to compute a calculated measure that has a value expression that is evaluated to produce values for the calculated measure.

14. The computer readable storage medium of claim 12 further comprising executable instructions to define expressions that reference values or ranges of values from other data model objects.

15. The computer readable storage medium of claim 12 further comprising executable instructions to compute a calculated dimension that contains members, where each member has an associated base measure determined by a calculation.

16. The computer readable storage medium of claim 12 further comprising executable instructions to dynamically determine dimension members based on the transformation of underlying data.

17. The computer readable storage medium of claim 12 further comprising executable instructions to determine dimension members related to a dimension hierarchy.

18. The computer readable storage medium of claim 1 further comprising executable instructions to calculate attributes.

19. The computer readable storage medium of claim 1 further comprising executable instructions to:
define a semantic domain describing a relational data source, wherein the relational data source does not explicitly contain hierarchy logic for dimensions; and
form at least one hierarchical base dimension as a data model object for the semantic domain.

20. The computer readable storage medium of claim 19 further comprising executable instructions to display a graphical user interface to facilitate the definition of a hierarchical dimension data model object.
